(19) United States
(12) Patent Application Publication
(10) Pub. No.: US 2026/0024510 A1
(43) Pub. Date: Jan. 22, 2026

(54) MANULENJO

(71) Applicants: Noel Paul Stookey, Blue Hill, ME (US); David P. LaPlante, Selkirk, NY (US)

(72) Inventors: Noel Paul Stookey, Blue Hill, ME (US); David P. LaPlante, Selkirk, NY (US)

(21) Appl. No.: 19/269,649

(22) Filed: Jul. 15, 2025

Related U.S. Application Data
(60) Provisional application No. 63/673,496, filed on Jul. 19, 2024.

(51) Int. Cl. G10D 1/05; G10D 3/02

(52) U.S. Cl. CPC G10D 1/05; G10D 3/02

(57) ABSTRACT

The present invention discloses a novel stringed musical instrument, inspired by the mandolin, the ukulele, and the banjo, and having characteristics of all three of these traditional instruments, with the instrument comprising a body, a neck attached to the body, means for attaching strings under tension to the neck and body, and sound amplification means within the body.

### CROSS REFERENCE TO RELATED APPLICATIONS

This application claims the benefit of the provisional patent application, U.S. Ser. No. 63/673,496 (“MANULENJO”), filed Jul. 19, 2024, by Stookey, Noel Paul, et al., and currently pending, which is hereby incorporated by reference.

### BACKGROUND OF THE INVENTION

The present invention relates to a new acoustic musical stringed instrument. The instrument is constructed primarily of wood and incorporates design features found in traditional mandolins, ukuleles, and banjos. However, not all of the design elements from those known instruments are found in the present invention, and many of the incorporated design elements are modified to allow for integration as well as to be able to provide an aesthetically pleasing sound.

As described herein, there is currently no acoustic stringed musical instrument that integrates components of the mandolin, ukulele, and banjo into a single musical instrument. Therefore, a solo musician cannot generate sounds on a single instrument that would otherwise be heard on the three different instruments. Moreover, new sounds that cannot be produced by any of the three known instruments individually are possible on the new musical instrument of the present invention. This is accomplished in part by having the musical instrument be double strung with eight strings, whereby the two lower sets of strings are tuned in octaves and the two upper sets of strings are tuned in unison. There is currently no acoustic stringed instrument known in the art that is double strung with eight strings, whereby the two lower sets of strings are tuned in octaves and the two upper sets of strings are tuned in unison.

It is therefore an object of the present invention to provide for a new acoustic stringed musical instrument that incorporates design elements from mandolins, ukuleles, and banjos.

It is a further object of the present invention to provide for a new acoustic

Stringed musical instrument that is double strung with eight strings, whereby the two lower sets of strings are tuned in octaves and the two upper sets of strings are tuned in unison.

It is yet a further object of the present invention to provide for a new acoustic stringed musical instrument that incorporates design elements from mandolins, ukuleles, and banjos that is constructed primarily of wood.

Other objects of the present invention will be readily apparent from the description that follows.

### SUMMARY

The instrument 1 of the present invention comprises the following elements: a body 100, which is substantially round and hollow, and a neck 200, which is elongate and is attached to the body 100. The body 100 is further comprised of a top 102, a rim 120, and a resonator 130. The top 102 is substantially circular, the rim 120 is a circular hoop, with a diameter substantially the same as the diameter of the top 102, and the resonator 130 is substantially circular, with an upwardly extending circular edge 132 about its perimeter and a closed bottom 138. The rim 120 is located between the top 102 of the body 100 and the resonator 130. The rim 120 further has a uniform height. The inside diameter of the resonator 130 is slightly greater than the outside diameter of the rim 120. The circular edge 132 of the resonator 130 has a uniform height that is less than the height of the rim 120. The rim 120 is configured to be placed into and affixed to the resonator 130 such that the lower portion 125 of the rim 120 is adjacent to the inner portion 134 of the upwardly extending circular edge 132 of the resonator 130. Disposed within the small gap between the rim 120 and the circular edge 132 of the resonator 130 are multiple spacer blocks 195. The spaces 196 between the spacer blocks 195 collectively serve as a sound hole for the instrument 1.

The top 102 of the body 100 is affixed to the top edge 128 of the rim 120. Affixed to the underside of the top 102 of the body 100 is an X-brace 180; located between the X-brace 180 and the underside of the top 102 is a bridge plate 190, positioned at the intersection of the crossing of the X-brace 180. The ends of the X-brace 180 are secured to the inside 124 of the rim 120.

The neck 200 is comprised of a peghead 210, a heel 220, a fretboard 230, and a spine 110. The heel 220 of the neck 200 is the end of the neck 200 located proximate to the body 100. The peghead 210 is located at the opposite end of the neck 200 from the heel 220. The fretboard 230 is placed onto the upper surface of the neck 200 and runs from the peghead 210 to the heel 220. A plurality of frets 232 are placed onto the fretboard 230, with each fret 232 oriented perpendicular to the longitudinal axis of the neck 200. The frets 232 are raised slightly above the surface of the fretboard 230, in a manner well known in the art.

The neck 200 is attached to the body 100 by a spine 110. The spine 110 is a wooden dowel rod. It extends from the neck 200 through the body 100. The heel 220 of the neck 200 has a aperture formed into it, oriented coaxially with the longitudinal axis of the neck 200. The first end of the spine 110 is inserted into the aperture of the heel 220 of the neck 200 and affixed thereto. The rim 120 of the body 100 has an aperture 122 formed through a portion of the rim 120 adjacent to the neck 200. The second end of the spine 110 passes through the rim aperture 122 and attaches to an inner portion 124 of the rim 120 located opposite the rim aperture 122. The spine 110 is then secured within the rim aperture 122. The heel 220 of the neck 200 is configured to be placed adjacent to the rim 120 of the body 100.

The resonator 130 of the body 100 has a central aperture 136 through which a vertical machine screw 139 passes, said screw 139 attaching to a bracket 170 which is clamped onto the spine 110 by means of a smaller machine screw.

The peghead 210 of the neck 200 has eight tuning pegs 212 placed thereon, with four on one side and four on the other. Each tuning peg 212 attaches the end of a string 300. Each tuning peg 212 may be rotated to change the tension of the string 300 attached thereto, in the manner well known in the art. The peghead 210 may be angled relative to the rest of the neck 200. The strings 300 are preferably steel strings, as are well known in the art.

An end button 140 is affixed to the outer surface 126 of the rim 120, opposite the rim aperture 122. The end button 140 passes through the rim 120 and into the second end of the spine 110, securing it to the rim 120. A tailpiece 150 is attached to the end button 140. The tailpiece 150 has an upper portion 152 that extends over a portion of the top 102 of the body 100, in an orientation relatively parallel to the top 102 of the body 100. A free floating bridge 160 is placed onto the top 102 of the body 100. Each string 300 is connected to the upper portion 152 of the tailpiece 150. Each string 300 runs from its corresponding tuning peg 212 to the tailpiece 150 over the bridge 160. Between the tuning peg 212 and the tailpiece 150, each string 300 is under tension, and the bridge 160 is held in place by the tension of the strings 300.

Different woods may be used in the construction of the instrument 1 of the present invention, selected for sound quality and aesthetic value. Maple, spruce, and other woods are contemplated to be used in the construction of the instrument 1. Edges and surfaces may be shaped and contoured as desired to aid in the use of the instrument 1 by a player and to add aesthetic value to the instrument 1. The entire instrument 1 may be finished with one or more coats of a lacquer or other preservatives to protect the wood from which it is made, as well as to enhance the aesthetic value of the instrument 1.

The instrument 1 is played by being held by a player, with the strings 300 being plucked or strummed by one of the player's hands at a location proximate to the bridge 160, while the strings 300 may be pressed against the frets 232 of the fretboard 230 by the other of the player's hands, both in a manner well known in the art.

It is to be understood that the foregoing and following description of the invention is intended to be illustrative and exemplary rather than restrictive of the invention as claimed. These and other aspects, advantages, and features of the invention will become apparent to those skilled in the art after review of the entire specification, accompanying figures, and claims.

### DESCRIPTION OF THE DRAWINGS

FIG. 1 is a top plan view of one embodiment of the invention.

FIG. 2 is a side view of the embodiment of the invention shown in FIG. 1. Certain interior features are shown using broken lines.

FIG. 3 is a top perspective view of the rim component of the invention (without X-brace).

FIG. 4 is a bottom perspective view of the rim component of the invention (with X-brace).

FIG. 6 is a bottom perspective view of the resonator component of the invention.

FIG. 7 is a top perspective view of the neck component of the invention.

FIG. 8 is a top perspective view of another embodiment of the invention.

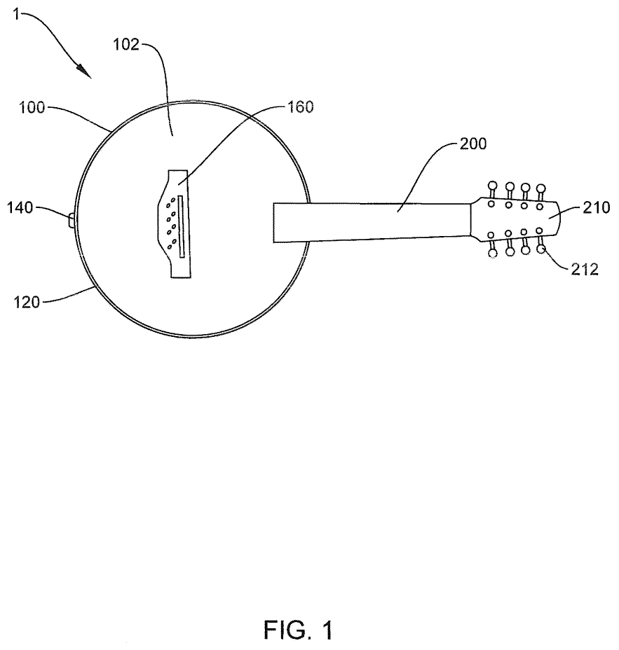

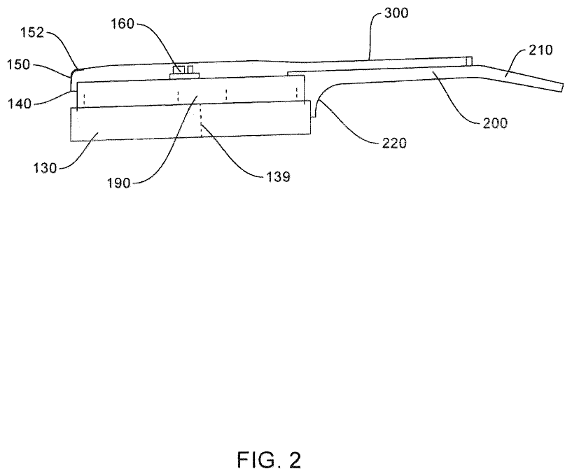

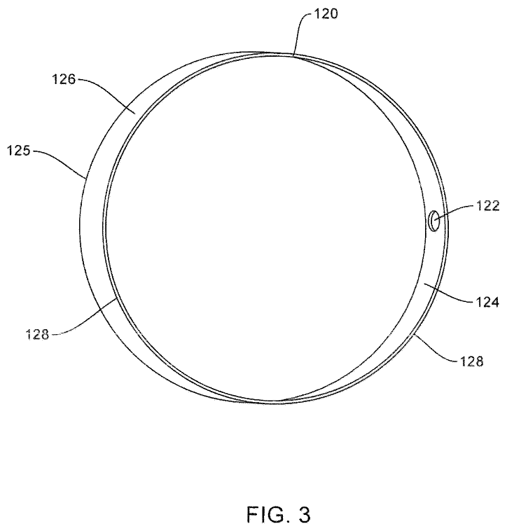

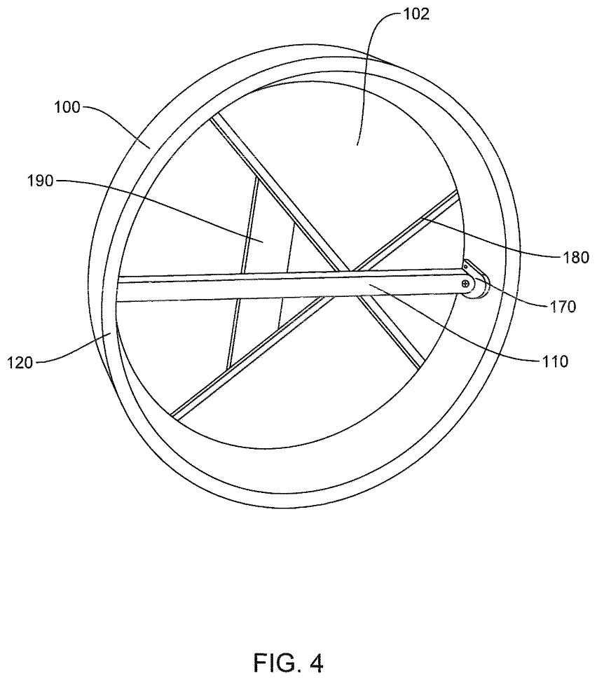

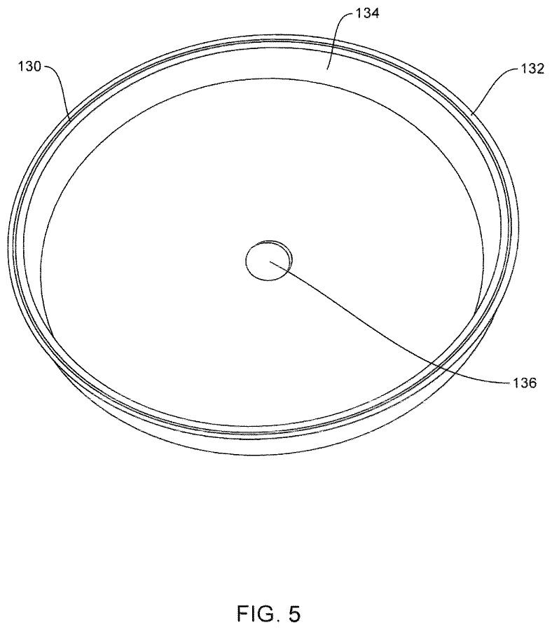

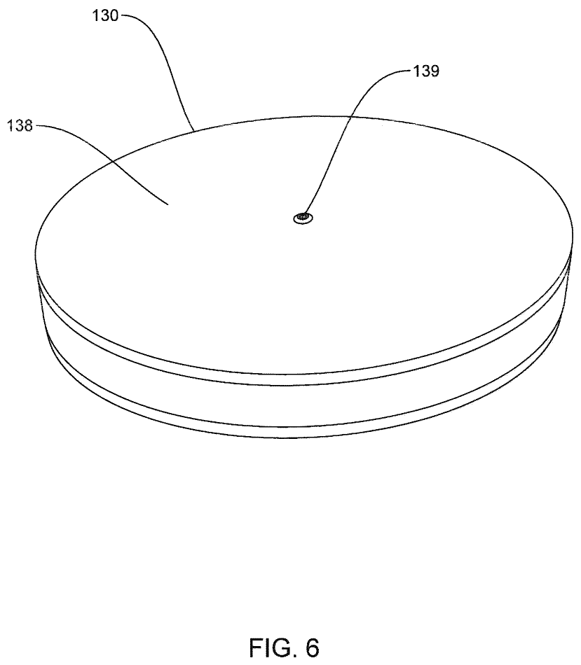

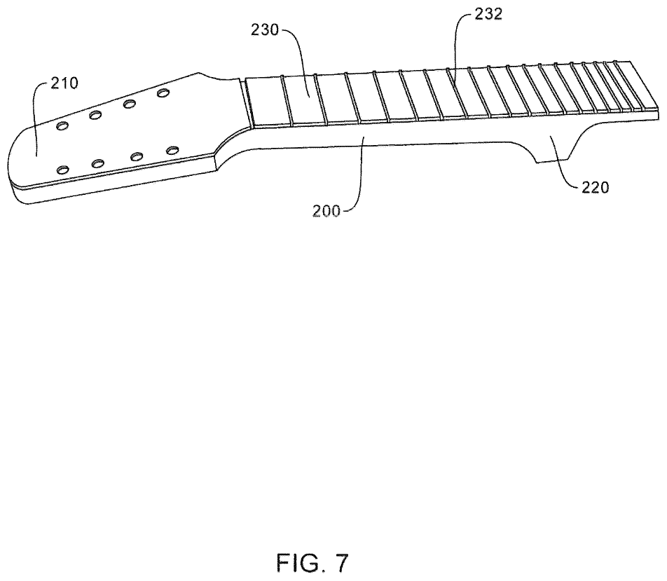

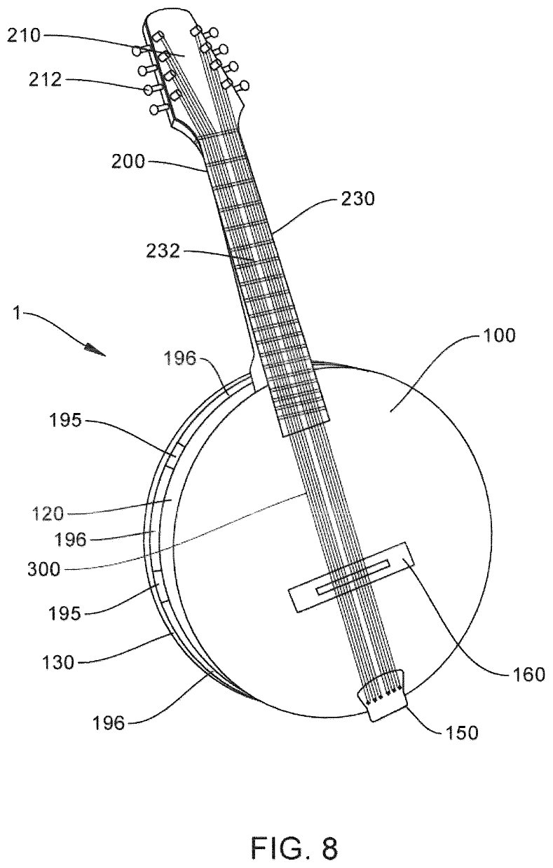

### DETAILED DESCRIPTION OF THE INVENTION

This invention comprises a stringed musical instrument 1 having a neck 200 and a round body 100 comprised of a top 102, a rim 120, and a resonator 130, which is suggestive of a banjo-style of construction. Instead of all the metal parts that one would find in a banjo, however, the invention uses a simple spruce top, more like a ukulele or a mandolin.

The top 102 of the body 100 of the instrument 1 is substantially circular in shape, with a diameter of approximately 13 inches, though other dimensions are also contemplated. The top 102 may be made of spruce, though other woods may be used. In one embodiment, the top 102 may be bookmatched, which means it is cut from the same piece of wood and then folded open like a book so that the grain matches on either side of the fold. Though the top 102 is substantially planar, in the alternative it may also have a slight bow, such that the body 100 of the instrument 1 has a somewhat convex upper profile.

The rim 120 is a substantially round hoop made of wood and has a diameter approximately the same as the diameter of the top 102 of the body 100. In the preferred embodiment, the rim 120 is approximately 13 inches in diameter, and 2½ inches in height, though other dimensions are also contemplated. The top edge 128 of the rim 120 is glued to the underside of the top 102 of the body 100. The lower portion 125 of the rim 120 is placed into the resonator 130.

The body 100 of the instrument 1 is reinforced by an X-brace 180. The X-brace 180 is comprised of a pair of wooden rods formed into an X shape. The X-brace 180 is glued to the underside of the top 102 of the body 100 and tapers out towards the edges. The X-brace 180 is notched into the top edge 128 of the rim 120. The notching adds strength at the edge of the body 100 of the instrument 1 against the tension and the pressure of the strings 300 on the top 102 of the body 100 of the instrument 1. The X-brace 180 configuration provides greater stiffness in the center of the body 100 and allows the top 102 of the body 100 to vibrate.

The body 100 is further reinforced by a bridge plate 190. The bridge plate 190 is located between the crossing portion of the X-brace 180 and the underside of the top 102 of the body 100, and secured thereto, typically with an adhesive. The bridge plate 190 may be a thin trapezoidal piece of wood, such as maple. The bridge plate 190 stiffens the area of the top 102 of the body 100 of the instrument 1 where the bridge 160 is going to be placed. The bridge 160 is placed on the upper surface of the top 102 of the body 100 above the location of the bridge plate 190 and is movable so that the intonation of the instrument 1 can be more easily adjusted.

A tailpiece 150 is used to hold the strings 300 to the body 100 of the instrument 1. The tailpiece 150 may be made of metal, such as stainless steel or brass, but other metals may be used, as well as other rigid materials. The tailpiece 150 has an L-shape, where the end which is attached to the body is oriented substantially vertically and in parallel with the rim 120 of the body 100, and the upper portion 152 of the tailpiece 152 is oriented substantially horizontally and parallel with the top 102 of the body 100. The tailpiece 150 may incorporate aesthetic designs, such as curved edges, apertures, and the like. The strings 300 are made of metal and are typical of strings used for musical instruments.

The resonator 130 may be a standard banjo resonator, which is substantially circular in shape and has a diameter of a little over 13 inches. The diameter of the resonator 130 may vary, though it should always have an inside diameter just slightly greater than the outside diameter of the rim 120. The resonator 130 has a substantially uniform circumferential edge 132 extending upward from a substantially circular bottom portion 138, forming a shallow bowl. Though the bottom portion 138 of the resonator 130 is substantially planar, in the alternative it may also have a slight bow, such that the body 100 of the instrument 1 has a somewhat convex lower profile. The height of the edge 132 of the resonator 130 is less than the height of the rim 120. Thus, when the rim 120 is placed into the resonator 130, an upper portion of the rim 120 extends beyond the top edge of the resonator 130. The resonator 130 uses a single machine screw 139 placed up through a center aperture 136 formed through the bottom portion 138 of the resonator 130, and then said screw 139 attaches to a bracket 170 located on a dowel rod that forms the spine 110 of the instrument 1, in a banjo-style construction.

The resonator 130 may be made of maple. Other woods may also be used. The resonator 130 may be covered on the back and on the side with a veneer, preferably maple. It is cut for the bindings that are installed at the top edge 132 and bottom edge of the resonator 130. There may be bindings in the rim 120 as well as in the resonator 130. The binding may be a strip of tape, for example, cellulose nitrate in a tortoise shell pattern. The binding is selected to present an aesthetic contrast to the body 100.

The rim 120 is fit into the resonator 130. The inside diameter of the upper edge 132 of the resonator 130 is slightly larger than the outside diameter of the rim 120, so that the rim 120 fits loosely into the resonator 130, leaving a circumferential space therebetween. A plurality of small blocks 195 is glued around the inner portion 134 of the resonator 130 between the resonator 130 and the rim 120, such that when the rim 120 sits in the resonator 130 there are gaps 196 between the blocks 195 that allow air flow between the air outside the body 100 and the air inside the body 100, collectively forming the equivalent of a sound hole. The blocks 195 are preferably made of wood.

The neck 200 of the instrument 1 extends from the body 100. In one embodiment, the neck 200 may be constructed out of a billet of maple or other hardwoods. In this embodiment, the neck 200 is constructed by splitting the billet in half, and then the two pieces are joined along their long axis with a piece of black veneer in the center to form the billet from which the neck 200 may be cut. In the alternative, a monolithic billet of wood may be used. A substantially planar fretboard 230 is glued to the top surface of the neck 200. There are multiple frets 232 attached to the fretboard 230. The frets 232 are small bars of metal oriented perpendicular to the longitudinal axis of the neck 200 and spaced apart from each other. The frets 232 may be hammered into corresponding slots formed into the fretboard 230. The fretboard 230 may be 17 inches in length. The fretboard 230 may have a rosewood veneer that is glued thereon. Other methods of construction of the neck 200 may also be used, and the length of the neck 200 may vary somewhat from the preferred length stated herein.

The neck 200 has a peghead 210 located at the distal end of the neck 200. The peghead 210 is the attachment point for one end of the strings 300 of the instrument 1. In one embodiment the peghead 210 of the neck 200 may be configured as what is known generally as a snakehead-style peghead 210, because it is wider at the end proximal to the rest of the neck 200 than it is at the distal end. Another embodiment may have the peghead 210 taper the other way, with a broader distal end. The peghead 210 may be angled downward from the rest of the neck 200. Other configurations of the peghead 210 are also contemplated. A rosewood veneer may be glued to the top portion of the peghead 210 of the neck 200. The peghead 212 is monolithic to the rest of the neck 200.

The peghead 210 comprises eight holes drilled into it at intervals, with the holes configured to accommodate the tuning pegs 232. There are four tuning pegs 212 located on one side of the peghead 210 and four tuning pegs 212 located on the opposite side of the peghead 210. Mandolin style tuning pegs 212 may be used. More complex tuning machine heads may also be used as tuning pegs 232, whereby a vertical post provides a point of connection to a string 300 and a lateral member provides a grip for the user to rotate, with the vertical post and the lateral member being connected by gearing. The two lower sets of strings 300 will be tuned in octaves and the two upper sets of strings 300 will be tuned in unison. As an example of this tuning configuration, the first of the two strings 300 comprising the lower pair of the lower set of strings 300 is tuned to the key of G and the second string 300 of that pair is tuned to the key of G one octave lower than the first string; the first of the two strings 300 comprising the higher pair of the lower set of strings 300 is tuned to the key of C and the second string 300 of that pair is tuned to the key of C one octave lower than the first string; both of the two strings 300 comprising the higher pair of the upper set of strings 300 are tuned to the key of E (same octave); and both of the two strings 300 comprising the lower pair of the upper set of strings 300 are tuned to the key of A (same octave). The end of each string 300 is attached to a tuning peg 212, with rotation of the tuning peg 212 causing the string 300 to wind around it, providing different amounts of string 300 tension based on how much of the string 300 is wound thereon. Increasing and decreasing the tension of each string 300 allows for the strings 300 to be tuned.

The end of the neck 200 proximate to the body 100 of the instrument 1 is the heel 220 of the neck 200. The heel 220 is located opposite the peghead 210 of the neck 200. The heel 220 extends downward from the rest of the neck 200 and provides a large area of contact between the neck 200 and the body 100 of the instrument 1. The heel 220 is monolithic to the rest of the neck 200. In one embodiment, a portion of the fretboard 230 extends beyond the heel 220 such that it overlaps a portion of the top 102 of the body 100 of the instrument 1.

The neck 200 may be shaped and rounded to provide a pleasing aesthetic as well as a comfortable grip for the player of the instrument 1. There may be a shaping of a contour on the heel 220 of the neck 200. There may be a contour towards the peghead 210 and a contour where the plane of the back of the peghead 210 joins the neck 200. Other aesthetic configurations of the neck 200 are also contemplated.

The body 100 of the instrument 1 is attached to the neck 200 by a spine 110. The spine 110 gives strength to the instrument 1 against the tension of the strings 300. The spine 110 is a wooden dowel rod that fits into an aperture formed into the end of the heel 220 of the neck 200. The dowel rod 110 supports the neck 200 and passes through the body 100 and is attached to the back of the rim 120 opposite the neck 200. A first end of the dowel rod 110 is inserted into the aperture formed into the heel 220 of the neck 200, then it is secured in place with a specialized heel bracket which bears against a short metal pin inserted through the dowel rod 110. There is a tensioning device with a screw which hooks onto a small metal rod which is inserted through the dowel rod 110 and then pushes against the rim 120 to pull the heel 220 of the neck 200 tight against the body 100.

The second end of the dowel rod 110 provides a location to attach the rim 120 at the front and the back of the dowel rod 110, and in a central location of the dowel rod 110 is an attachment point for attaching the resonator 130 by means of a machine screw 139. The resonator 130 has a central aperture 136 through which a metal machine screw 139 is placed, with the end of the machine screw 139 attaching to a bracket 170 attached to the dowel rod that forms the spine 110 inside the body 100 of the instrument 1.

An end button 140 is located on the exterior of the body 100 of the instrument 1 opposite the attachment point of the neck 200. The end button 140 is typically made of metal, similar to the metal used for the tailpiece 150, but other metal may be used, or even materials other than metal. The end button 140 has a wood screw thread that threads through the rim 120 and into the end of the second end of the dowel rod 110, and then a machine screw thread that it threads into. The end button 140 holds the second end of the dowel rod 110 securely in place. A vertical aperture formed through the end button 140 provides for the attachment of the tailpiece 150. The upper portion 152 of the tailpiece 150 attaches the ends of the strings 300 and absorbs the string tension.

The bridge 160 is a substantially rectangular piece located proximate to the tailpiece 150. The position of the bridge 160 can be adjusted back and forth to adjust the intonation of the instrument 1. The bridge 160 may be made of wood.

Assembly of the instrument 1 is as follows: the top 102 of the body 100 is fitted to the rim 120 and the bottom of the rim 120 is placed into the resonator 130, thereby forming the body 100. The neck 200 is assembled with the fretboard 230 and frets 232 and the tuning pegs 212 and then fitted to the rim 120 by use of the spine 110. A bridge 160 is placed on the body 100, and a tailpiece 150 is placed on the far side of the body 100 to hold the strings 300. The strings 300 are attached at one end to the tuning pegs 212 and at the other end to the tailpiece 150, passing over the bridge 160. Then the strings 300 are tightened by the tuning pegs 212. The bridge 160 is free floating and held in place by the tension of the strings 300, similar to a mandolin or a banjo.

The entire instrument 1 may be treated with several coats of lacquer, with sanding in between, to give it a sealed finish.

The forgoing discloses one embodiment of the invention. However, other embodiments are contemplated, and the invention is not limited to the disclosed embodiment. Variations to the design disclosed herein are considered part of the invention.

I claim:

1. A musical instrument comprising
a body, a neck, a plurality of tuning pegs, a tailpiece, and a plurality of strings under tension,
wherein the body is substantially round and hollow and internally reinforced against the tension of the strings,
the neck is elongate and has a peghead located at a distal end of the neck and a heel located at a proximate end of the neck opposite the peghead, whereby the heel of the neck is located proximate to the body and the neck is internally reinforced against the tension of the strings,
the plurality of tuning pegs are attached to the peghead in a manner that provides for each said tuning peg to rotate,
the tailpiece attached to the body at a side of the body located opposite the neck, and
the plurality of strings corresponding in number to the plurality of tuning pegs, with each of the plurality of strings being attached at one end to a corresponding tuning peg and attached at a second end to the tailpiece;
whereby a rotation of a tuning peg in a first direction will increase the tension in its corresponding string, and a rotation of said tuning peg in a second and opposite direction will decrease the tension in its corresponding string.

2. The musical instrument of claim 1 wherein
the body is comprised of a top, a rim, and a resonator,
with the top being substantially circular,
the rim being a circular hoop, with a diameter substantially the same as the diameter of the top, said rim having a uniform height, and
the resonator being substantially circular, having an upwardly extending circular edge and a closed bottom, with an inside diameter of the resonator being slightly greater than an outside diameter of the rim and the circular edge of the resonator having a uniform height that is less than the uniform height of the rim;
wherein the top of the body is placed onto and affixed to a top edge of the rim, and the rim is placed into the resonator such that a lower portion of the rim is adjacent to an inner portion of the circular edge of the resonator.

3. The musical instrument of claim 2 wherein
a bridge is located on an upper surface of the top of the body of the instrument whereby said bridge supports the plurality of strings running from the tuning pegs to the tailpiece, with the bridge being configured to be held securely in place by the strings when said strings are under tension and to be moveable when the tension of the strings is relaxed.

4. The musical instrument of claim 2 wherein
the placement of the rim into the resonator creates a gap between the lower portion of the rim and the inner portion of the resonator, and
a plurality of spacer blocks are disposed within said gap, such that the spaces between the spacer blocks collectively serve as a sound hole for the instrument.

5. The musical instrument of claim 2 wherein
an X-brace is affixed to an underside of the top of the body, said X-brace comprised of a pair of intersecting elongate members, whereby each elongate member spans an interior of the body and is attached at its ends to an inside surface of the rim,
whereby the X-brace adds rigidity to the body and strengthens the instrument against the tension of the strings.

6. The musical instrument of claim 5 wherein
a bridge plate is located between the X-brace and the top of the body and affixed thereto, whereby the bridge plate is substantially planar and is positioned at an intersection of the pair of elongate members of the X-brace.

7. The musical instrument of claim 1 wherein
there are eight tuning pegs, with four tuning pegs located on one side of the peghead and four tuning pegs located on an opposite side of the peghead, and
eight strings, with the strings grouped into four pairs of two strings each,
whereby the two lower pairs of strings are tuned in octaves and the two upper pairs of strings are tuned in unison.

8. The musical instrument of claim 7 wherein
there are eight apertures formed into the peghead, with each of the eight tuning pegs configured to be partially placed into one of the eight apertures and retained therein.

9. The musical instrument of claim 1 wherein
the neck is further comprised of a fretboard, said fretboard being placed onto an upper surface of the neck and affixed thereto, running from the peghead to the heel, with a plurality of frets placed onto said fretboard and spaced apart from each other, with each fret oriented perpendicular to a longitudinal axis of the neck and each said fret being raised slightly above the upper surface of the fretboard.

10. The musical instrument of claim 1 wherein the peghead is angled relative to the neck.

11. The musical instrument of claim 2 further comprising
a spine, said spine being a wooden dowel rod extending from the neck into the body,
wherein the heel of the neck comprises a aperture, oriented coaxially with the longitudinal axis of the neck, and the rim comprises an aperture,
with a first end of the spine being inserted into the aperture of the heel of the neck and affixed thereto, and a second end of the spine being inserted into and through the aperture of the rim and affixed to an inner portion of the rim located opposite the rim aperture;
whereby the spine adds rigidity to the instrument against the tension of the strings.

12. The musical instrument of claim 11 further comprising
an end button affixed to an outer surface of the rim and located opposite the rim aperture, with the end button passing through the rim and into the second end of the spine.

13. The musical instrument of claim 12 wherein
the tailpiece is attached to the end button, with the tailpiece having an upper portion that extends over a portion of the top of the body in an orientation substantially parallel to the top of the body, whereby the plurality of strings are attached to the upper portion of the tailpiece.

14. The musical instrument of claim 11 wherein
the resonator has a central aperture through which a vertical machine screw passes, said screw attaching to a bracket which is clamped onto the spine.

15. The musical instrument of claim 2 wherein
there are eight tuning pegs, with four tuning pegs located on one side of the peghead and four tuning pegs located on an opposite side of the peghead, and
eight strings, with the strings grouped into four pairs of two strings each,
whereby the two lower pairs of strings are tuned in octaves and the two upper pairs of strings are tuned in unison.

16. The musical instrument of claim 15 wherein
there are eight apertures formed into the peghead, with each of the eight tuning pegs configured to be partially placed into one of the eight apertures and retained therein.

17. The musical instrument of claim 2 wherein
the neck is further comprised of a fretboard, said fretboard being placed onto an upper surface of the neck and affixed thereto, running from the peghead to the heel, with a plurality of frets placed onto said fretboard and spaced apart from each other, with each fret oriented perpendicular to a longitudinal axis of the neck and each said fret being raised slightly above the upper surface of the fretboard.

18. The musical instrument of claim 2 wherein
the peghead is angled relative to the neck.

19. The musical instrument of claim 2 wherein
the top is made of wood, the rim is made of wood, the resonator is made of wood, and the neck is made of wood.

20. A musical instrument comprising
a body, a neck, a spine, eight tuning pegs, a tailpiece, a bridge, and eight strings under tension;
wherein the body is substantially round and hollow and made of wood and is comprised of a top made out of wood, a rim made out of wood, and a resonator made out of wood,
with the top being substantially circular,
the rim being a circular hoop with a diameter substantially the same as the diameter of the top and said rim having a uniform height, with the rim being reinforced by an X-brace affixed to an underside of the top of the body, said X-brace comprised of a pair of intersecting elongate members, whereby each elongate member spans an interior of the body and is attached at its ends to an inside surface of the rim, and by a bridge plate located between the X-brace and the top of the body and affixed thereto, whereby the bridge plate is substantially planar and is positioned at an intersection of the pair of elongate members of the X-brace, and
the resonator being substantially circular and having an upwardly extending circular edge and a closed bottom with an inside diameter of the resonator being slightly greater than an outside diameter of the rim and the circular edge of the resonator having a uniform height that is less than the uniform height of the rim, wherein the top of the body is placed onto and affixed to a top edge of the rim, and the rim is placed into the resonator, whereby the placement of the rim into the resonator creates a gap between a lower portion of the rim and an inner portion of the resonator, and a plurality of spacer blocks are disposed within said gap, such that the spaces between the spacer blocks collectively serve as a sound hole for the instrument;
the neck is elongate and made of wood and has a peghead made out of wood, a heel made out of wood, a fretboard made out of wood, and a plurality of frets made out of metal,
with the peghead located at a distal end of the neck whereby the peghead is angled relative to the neck,
the heel located at a proximate end of the neck opposite the peghead whereby the heel of the neck is located proximate to the body,
the fretboard being placed onto an upper surface of the neck and affixed thereto running from the peghead to the heel, and
the plurality of frets placed onto said fretboard and spaced apart from each other, with each fret oriented perpendicular to a longitudinal axis of the neck and each said fret being raised slightly above the upper surface of the fretboard;
the spine is a wooden dowel rod extending from the neck into the body, wherein the heel of the neck comprises a aperture, oriented coaxially with the longitudinal axis of the neck, and the rim comprises an aperture, with a first end of the spine being inserted into the aperture of the heel of the neck and affixed thereto, and a second end of the spine being inserted into and through the aperture of the rim and affixed to an inner portion of the rim located opposite the rim aperture, whereby the spine adds rigidity to the instrument against the tension of the strings;
the resonator has a central aperture through which a vertical machine screw passes, said screw attaching to a bracket which is clamped onto the spine;
the tuning pegs are attached to the peghead in a manner that provides for each said tuning peg to rotate;
the tailpiece is made of metal and is attached to an end button affixed to an outer surface of the rim and located opposite the rim aperture, with the end button passing through the rim and into the second end of the spine, with the tailpiece having an upper portion that extends over a portion of the top of the body in an orientation substantially parallel to the top of the body;
each of the strings is attached at one end to a corresponding tuning peg and attached at a second end to the upper portion of the tailpiece; and
the bridge is located on an upper surface of the top of the body of the instrument whereby said bridge supports the strings running from the tuning pegs to the tailpiece, with the bridge being configured to be held securely in place by the strings when said strings are under tension and to be moveable when the tension of the strings is relaxed;
whereby a rotation of a tuning peg in a first direction will increase the tension in its corresponding string, and a rotation of said tuning peg in a second and opposite direction will decrease the tension in its corresponding string.
